(19) United States
(12) Patent Application Publication
(10) Pub. No.: US 2013/0110593 A1
(43) Pub. Date: May 2, 2013

(54) THIRD PARTY ADVERTISING ON ENVELOPES AND BOXES

(71) Applicant: James S. Fowler, West Homestead, PA (US)

(72) Inventor: James S. Fowler, West Homestead, PA (US)

(21) Appl. No.: 13/659,434

(22) Filed: Oct. 24, 2012

Related U.S. Application Data
(60) Provisional application No. 61/628,441, filed on Oct. 31, 2011.

(51) Int. Cl. G06Q 30/02; B65D 5/42; B65D 27/00

(52) U.S. Cl. 705/14.4; 229/68.1; 229/70; 229/102.5

(57) ABSTRACT

An envelope comprising a rectangular panel having parallel long and short sides with a front outer surface onto which a delivery address is made visible and a reverse side opposite the delivery address side. The envelope includes at least one third party advertising message on its reverse side. Ideally, a stamp cancellation for that envelope can be sold for additional third party advertising messages/promotions. The same applies to shipping boxes, packing boxes of movers and even those box-like containers in which foodstuffs are packaged after preparation.

### CROSS-REFERENCE TO RELATED APPLICATION

This application is a perfection of U.S. Provisional Application No. 61/628,441, filed on Oct. 31, 2011, the disclosure of which is fully incorporated by reference herein.

### FIELD OF THE INVENTION

The present invention primarily relates to postal and overnight mail delivery. More particularly, this invention provides mailing envelopes and boxes, and a related method of generating third party advertising revenues therewith. Alternatively, this same invention may be used to generate advertising revenue by selling advertising space to third parties on bank envelopes (including those used for deposits and automated teller machines), moving boxes, appliance packages, tissue boxes and the disposable boxes of certain foodstuffs including but not limited to pizza delivery boxes, donuts and other baked goods, and drive-through variety foods (sandwiches, hot dogs, fast food meals, etc.).

### BACKGROUND OF THE INVENTION

Stories about the financial shortfalls of the U.S. Postal Service are making daily headlines on the evening news and newspapers. There are repeated requests for any suggestive means for making up operating losses without having to resort to fewer customer services, i.e. eliminating Saturday mail deliveries, and/or reduced over-the-counter mail stops, or post stations, especially in rural locales. At the time of filing this application, another first class postage stamp increase was just announced following a larger increase not that long ago. Meanwhile, consumer disdain for such increases drives customers to more and more electronic message delivery means further facilitating the downward cycle of increased costs with reduced revenues.

The U.S. Postal Service has some familiarity with advertising/sponsorship activities. They have supported the team of American cyclists in the Tour de France for years. There have also been USPS sponsored drivers in certain NASCAR and other auto racing series. On the flipside, the U.S. Postal Service offers a free movers' guide packet of information in which over a half dozen sponsors offer moving-related coupons and discounted services.

In the past, there have been sporadic links to mailing materials and advertisers per se. D'Opdorp U.S. Pat. No. 290,179, from 1883, offered a single sheet of letter-writing paper around which numerous advertisements were situated. After writing correspondence on the blank sheet of paper, it can be separated from the ads and then folded for stamping and mailing to its intended recipient.

Cohn U.S. Pat. No. 835,850 (from 1906) offered a fanciful envelope arrangement with a purposefully-shaped, product promoting window. As shown therein, mailing envelopes with a window shaped like a pickle or cigar could be used for further product promoting.

Greason U.S. Pat. No. 3,356,285 proposed a mailing envelope that had an intentional inner flap 12 situated inside of the envelope's outer sealing flap 13. The purpose of that inner flap was to print advertising and/or a redeemable coupon for user separation before sealing the contents in the remainder of that main envelope. Years later, due to the advancement of automatic envelope filling machines, the Greason coupon concept was improved on through the addition of an alternate outside coupon configuration in Purcell et al. U.S. Pat. No. 6,196,447.

Finally, Fisher U.S. Pat. No. 7,334,719 (in 2008) offered a new arrangement of banking envelope, and related method of use, that enabled the banking institution to engage in the promotion of at least one unrelated business institution located in near proximity to that bank.

As Congress and bureaucrats dally over ways to slash and cut for making up budgetary shortfalls, the losses continue to mount. All the while, there is a viable means for third party promoting that hasn't been sufficiently exploited. This invention addresses such promotional needs . . . even more so as a fast and easily implementable solution to the Postal Service's continuing indebtedness. While the printing of advertising on the exterior of mailing envelopes and boxes may increase their respective costs of production, the use of such space for viable local, regional, nationwide and international advertising will more than offset such costs. If done properly, it can rapidly be exploited as a near “overnight” source of income generation for the USPS and/or other overnight mail service providers. Should there be a current regulatory prohibition against such advertising exploitation, it should be much easier to lift that Federal ‘bar’ than it would be to sell the public on paying more and more for getting less and less first class mail delivery services.

For still other box and envelope applications, there is a substantial quantity of “wasted space” that can be used to capture consumers' attentions via third party advertising. These can be in the form of print ads and website advertising, or more sophisticated items like discount coupons, redemptions and/or other promotions. These are not like any sort of add-on contest, grocery receipt coupon or other promotional sticker. Nor is like advertising on one's packaging some thing or service that the primary vendor/package also makes and/or sells. For example, an Amazon box advertising a book or video that it is selling is not truly a “third party” advertisement according to this invention. It is more like a cross promotion of something that Amazon also sells.

Similarly, the McDonalds' Monopoly game “pieces” and promotional stickers made popular by Ad-a-note.com are added to a food product box and daily newspaper, respectively. But are not made integral with the packaging per se.

### SUMMARY OF THE INVENTION

The present invention is embodied in an envelope to which one or more third party advertising messages are intentionally and professionally added. Ideally, the reverse side of a typical first-class mailing, i.e. opposite the addressed and stamped side, is a ripe region for such advertising exploitation. That can be accomplished through purposeful pre-printings of envelope space, sold (a) at a premium and, (b) more preferably, on a time-sensitive, rotating basis with at least some of said sold ads being very geographically specific. Through the advent of more and more mobile media promotions, it is conceivable that discounts, coupons and other referral information may be purposefully added to the reverse side of most first class mailings. These could include the cell phone read square bar codes found on newspapers and many other (magazines) print media.

Alternately, these same envelope sides can be supplied with squares of other promotions, including but not limited to internet-based businesses. A typical, pre-printed arrangement for a reverse-side envelope could include a plurality of local, regional, statewide, nationwide and even international company promotional materials. Such promotions may be as simple as company listings, including phone numbers, email addresses and/or websites. Alternately, more elaborate promotional means including redeemable coupons, tabs and/or other cross-promotional activities may be pre-printed thereon.

The same can be said on all but the “business side”, or addressed box front to an overnight mailer. In some instances, such padded envelopes are so thick as to be more box shaped with 6 or more sides (often depending on the size and shape of the materials to be shipped therein). While current rules condone carrier/delivery self-promotion with such packaging, it is hard to fathom why the less critical/necessary side flaps or reverse end (opposite the address side) of an Express Mail, Priority Mail box and/or UPS, FedEx, DHL box couldn't also be used to “sell” advertising space . . . either related to a particular service, region or the like.

Alternately, it is conceivable to modify today's stamp canceling equipment for adding, after-the-fact, promotional production advertising to an envelope and/or mailing box. For instance, the USPS often provides a regional message like “Go Steelers” rapidly across the address side in a stamp cancellation exercise. Such rapidly etched/printed messages promote community and enhance overall goodwill for the USPS. Taken one step further, that same stamp cancellation printing activity be modified to run a Buy One-Get One promotion for a local grocery chain, of course at a fee . . . per cancellation. That validation can run near the stamped corner across the front of most any first class stamped card, billing statement or the like. Should greater visibility be desired (AND PAID FOR), such etched or printed messages can be rapidly scrolled across the top corners of said envelopes opposite the addressed envelope front, in place of OR in addition to any cross-stamp promotional printings.

In some cases, panel sections of the main, outer envelope or box body—(inside OR out) may be pre-printed with promotional coupons from businesses other than the mail service deliverer (the USPS or otherwise), or other than the primary business itself (such as a FedEx or U-Haul) selling ad space on their delivery and/or shipping boxes. Preferably, coupons would only be made available for use (i.e. redemption) after being separated by disassembling the envelope (or box) and tearing off each coupon, possibly along pre-perforated regions thereon.

The advantage of providing advertising from various institutions enables the solicitation of advertising fees from such institutions for EACH envelope so issued. Revenues from promoting the products or services of another business will not only pay for the expense of print advertising, they should make a deep dent into otherwise seemingly insurmountable USPS daily operating expenses.

For various disposable food packages, third party advertisements (and promotions) may be included onto (i.e. made integral with) the exterior of pizza boxes, donuts and other baked goods, and even fast food boxing. To some extent, and for greater consumer “surprise”/intrigue, it may be better still to add redeemable promotions to these box interiors so that inspection, and subsequent redemption is only practical after purchase of the food goods. In those cases, it is recommended that ample paper liners be added for providing greater assurance that the paid-for ads will be “seen” and not blurred or otherwise sullied by any portions of the foodstuffs deposited therein. In particular, it may prove difficult selling ad space to the insides of a pizza box when those ads get lost behind sauce and/or extra cheese.

As stated earlier, these third party envelope and/or box ads are not add-ons in the sense of a McDonalds' game piece promotion. Nor not like the sticker additions to magazines and daily newspapers provided by companies like Ad-a-note.com. Rather, these third party ads are printed directly onto the envelopes/boxes and remain intact unless and until a consumer physically cuts out the coupon for in-store redemption.

### BRIEF DESCRIPTION OF DRAWINGS

Further features, advantages and objects of this invention will be made clearer with the detailed description made in conjunction with the drawings in which:

FIG. 1 is a front plan view of a first class envelope for a greeting card showing an advertisement as part of a stamp cancellation;

FIG. 2A is a rear plan view of the envelope from FIG. 1 showing an alternate set of advertisements, including a cell phone square bar code, across the rear face of said envelope;

FIG. 2B is a perspective view of an alternate bank deposit envelope showing third party advertising across its one face;

FIG. 3 is a top perspective view of an overnight mailer box showing a plurality of advertisements, including redeemable coupons, along the top and side panels;

FIG. 4 is a rear plan view of the mailer box from FIG. 3 showing a plurality of advertisements across the rear face of same;

FIG. 5 is a top perspective view showing a representative disposable box for food products, i.e. donuts, closed to show the third party ads sold for the box exterior;

FIG. 6 is a perspective view of the donut box from FIG. 5 with the lid hinged open, and a protective liner positioned therein, to show some of the third party ads sold for that box interior; and

FIG. 7 is a top plan view of the box from FIG. 6 before it is folded into shape and foodstuffs are inserted therein.

### DETAILED DESCRIPTION OF PREFERRED EMBODIMENTS

In the following detailed description, common features among the various embodiments are commonly numbered to the extent possible with the same or substantially similar components being assigned the same last two digits in the next hundred series.

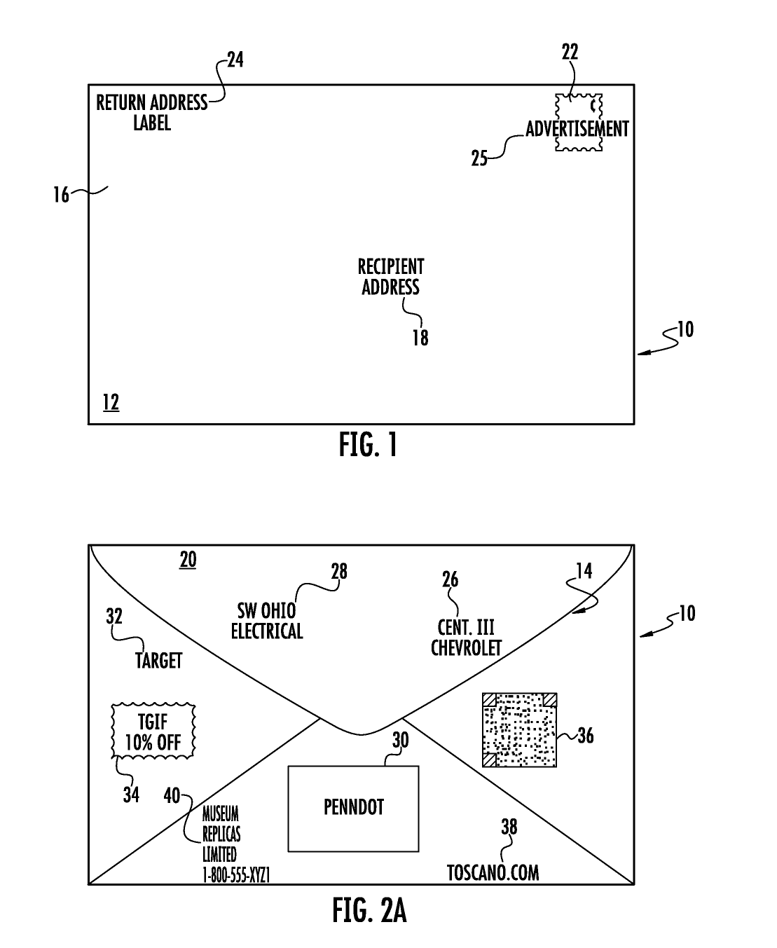

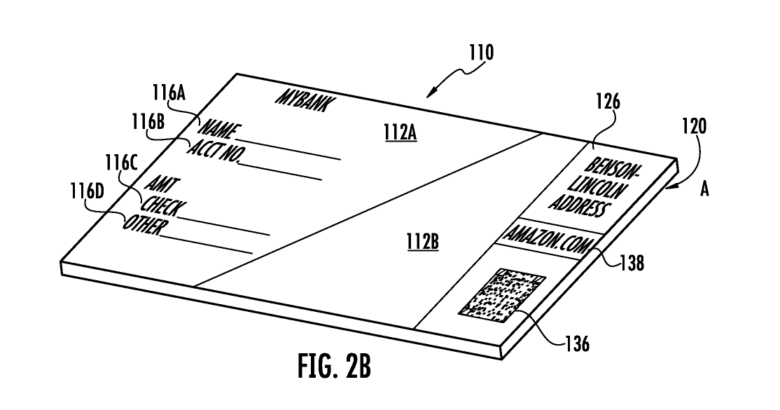

Referring now to FIGS. 1 and 2A, a typical greeting card envelope, generally 10, in accordance with the present invention is made from a blank of a suitable material such as paper. The blank has two opposing surfaces, one of which will become the outer surface 12 of the assembled envelope and the other the inner surface 14 of folded envelope 10. For purposes of this discussion, outer surface 12 will consist of two main sections/sides or “halves”, the address side 16 onto which the recipient's mailing address 18 is written, and the reverse, or contents closing side 20. Address side 16 is also the side receiving the postage stamp 22 and/or metered postage. More often, it also includes a return address 24 in the corner opposite stamp 22, either handwritten or as a self-adhering label. The envelope in which a billing statement or other business oriented correspondence is enclosed, contains substantially similar components, but typically shows an address window (of cellophane) in its address side equivalent.

Envelope 10 of FIG. 1 cannot include distracting or superfluous third party advertising on the face of address side 16. It must be maintained substantially clutter-free to better assist mail reader/routers in detecting zip codes for rapid mail processing. The stamp area, by contrast, may be provided with a printed legend. It can serve as an alternative stamp cancellation indicator. See, for example, element 25 in FIG. 1. The USPS has been known to occasionally provide regional messages of pride, such as “Go Steelers!”, in the equipment used to process and cancel postage. For the properly negotiated fee, regionally, locally or even nationally, the same cancellation legend can be replaced for a preset time with “Try a McRib®, only $1.99”, or with another representative, time-sensitive ad.

Alternatively, or in addition to scrolled stamp cancellation 25, the reverse/closing side 20 of envelope 10 can be provided with a series of local 26, regional 28, statewide 30 and/or Federally-owned/sponsored 32 ads, often with time sensitive promotions including redeemable coupons 34. On the middle right edge to closing side 20, there is shown a representative cell or mobile phone-read bar square 36 which can be redeemed by individuals having certain phone applications added thereto. These would NOT be specific to the particular, intended recipient but can be customized for same when proper security measures are included therewith. Still other advertising space can be sold for internet-based websites 38 and/or other, predominantly catalog-based operations 40.

Advertising from a plurality of third party institutions may be applied to closing side 20 through pre-printing. Alternately, ads may be printed AFTER full envelope assembly. Either way, the “customer” who receives the envelope with its otherwise intended contents will also receive advertising material from a plurality of institutions including those not necessarily affiliated with the mail delivery service provider.

To minimize the cost of pre-printing envelopes, an advertising contract may be executed with multiple entities using the first revenues obtained towards the costs of printing such advertising (if such costs cannot be surcharged to the respective entities). Then all extra advertising “income” can be used as a pure profit generator. In this manner, advertising companies, websites, mobile phone bar coders and/or coupon deliverers may exploit the otherwise unused, or underused blank/“dead” sides to mailer envelopes, overnight boxes and other packages. Revenues for the advertising companies will increase (through increased advertising exposure) while also enhancing exposure for websites and catalog companies who are otherwise struggling to let people know that they exist and are OPEN FOR BUSINESS. At the same time, revenues for the package delivery companies increases, especially from those magazine, catalog and/or website sellers who still need to ship product to their intended customers in otherwise bland, generic packaging. Should mail recipients see a flashy ad on the exterior of envelopes or delivered packages, their interests may be stirred to the point of looking up websites not otherwise investigated.

In FIG. 2B, the alternate embodiment for an automated teller machine (or ATM) bank deposit envelope 110 typically includes a information flap 112A onto which the depositor's name 116A, account number 116B and deposit particulars, i.e. check amounts 116C and other (cash) 116D may be handwritten. Behind info flap 112A, the remainder of the bank envelope's outer surface 112B resides. Each bank envelope 110 would also include a closing side 120 (indicated by Arrow A). The latter closing side may be “sold” with much of the same advertising as mentioned above for FIGS. 1 and 2A. Because of fewer restrictions against “clutter”, and the need for only a limited region on which to imprint depositor information/data, the same front to bank envelope 110 may be supplied with some front-based, more highly visible (and hence, more costly to “rent”) ads like a local business 126, bar square read 136 and an internet based company 138. The lone distinction from all other envelope advertising is that, coupon printing would not be encouraged UNLESS such coupons can be made severable (e.g. by printing on a separate flap/addendum).

Similar to a standard mailer envelope, many banks use a pocketed “sleeve-like” envelope in which to deposit currency (both bills and loose change) most often when a customer stops at their counter (inside the bank or at the drive-through teller) for having one's check cashed. That's true regardless of whether said check is a personal check or one of a payroll variety. This invention can be used for placing pertinent, key advertising on the unused sides of said pay/mailer bank envelopes. And since they do NOT require account particulars (like the other variety of bank envelopes shown and described above), it is possible to situate viable third party advertising on virtually all flat surfaces (both front and back sides) to envelopes like these (not shown).

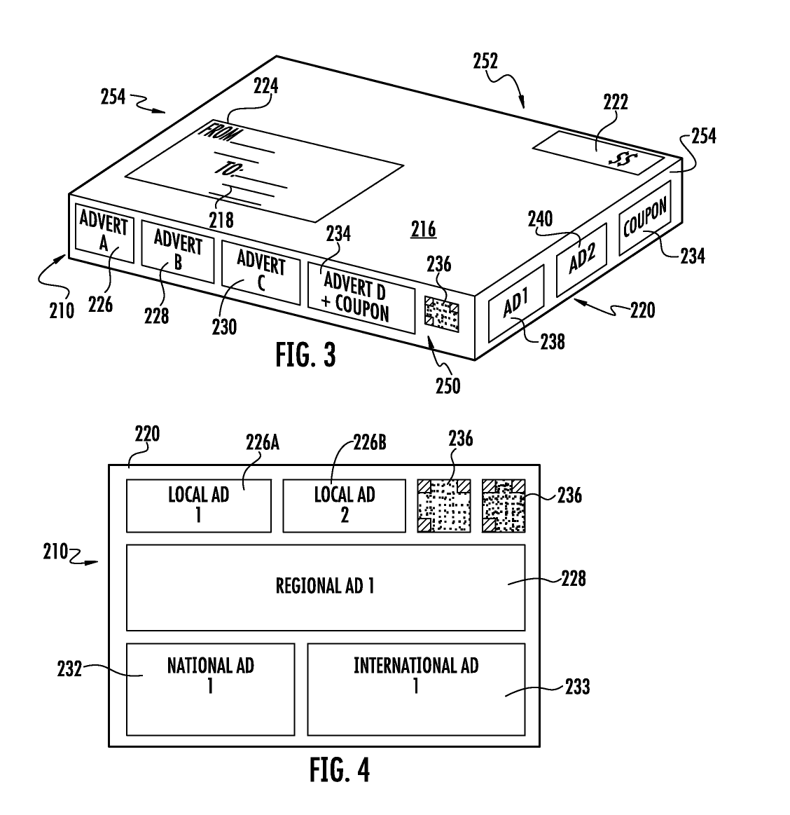

In FIGS. 3 and 4, there is shown a typical, three-dimensional box-type package 210 having its own top 216, bottom 220, front 250, rear 252 and side 254 panels which may vary widely in width and height. Most every side, top/bottom to these boxes can serve as prime space for third party advertising so long as the addressing area on the box top 216 is left relatively “clean” of ads and stamp/postage 222 is not completely overrun with ads. As best seen in FIG. 4, a plurality of promotions may be pre- or post-printed on the bottom 220 or under side to package 210. Depending on shipping destinations, the local ads 226A and 226B. regional ad 228 and national ad 232 may be supplemented with one promoting an international service provider 233. One or more bar squares 236A and 236B may also be “sold” on that same box surface.

The front edge 250 to box/container 210 may be supplied with their own sets of ads 250A, B, C and D (the latter adding a coupon element thereto) with yet another bar square 236C duly sized to exploit every inch of useable ad space. These ads can be sold as interrelated promotions, theme-based and/or in incremental redemption times from the same advertiser. Along one of the side flaps 254, there are shown still other sold promotions, including ad 254-1, 254-2 and a redeemable coupon 234.

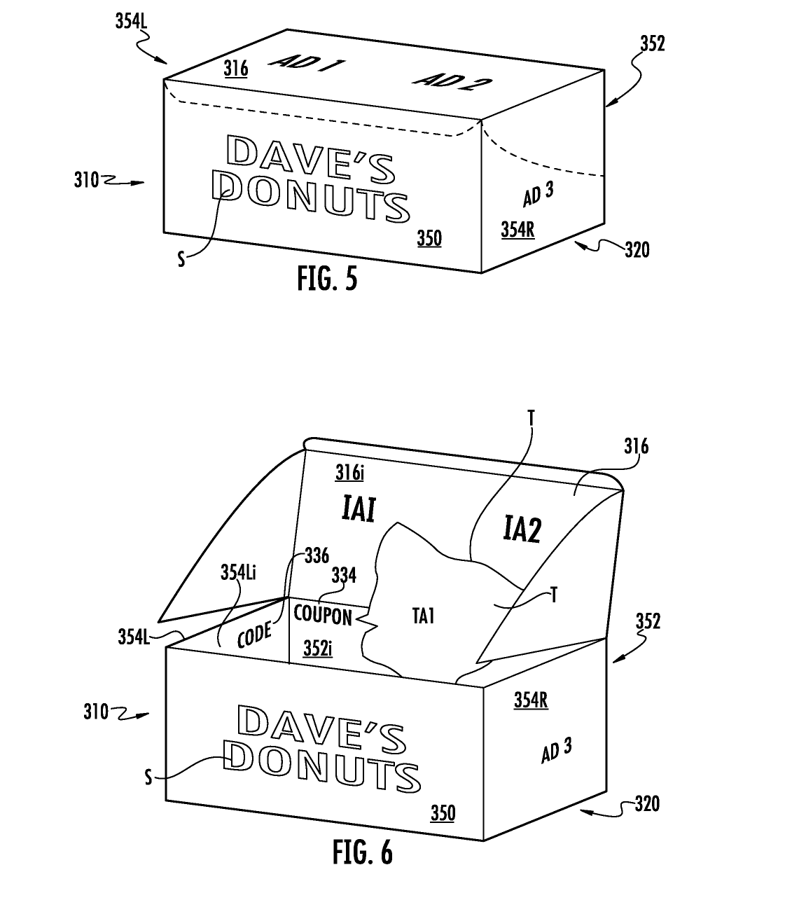

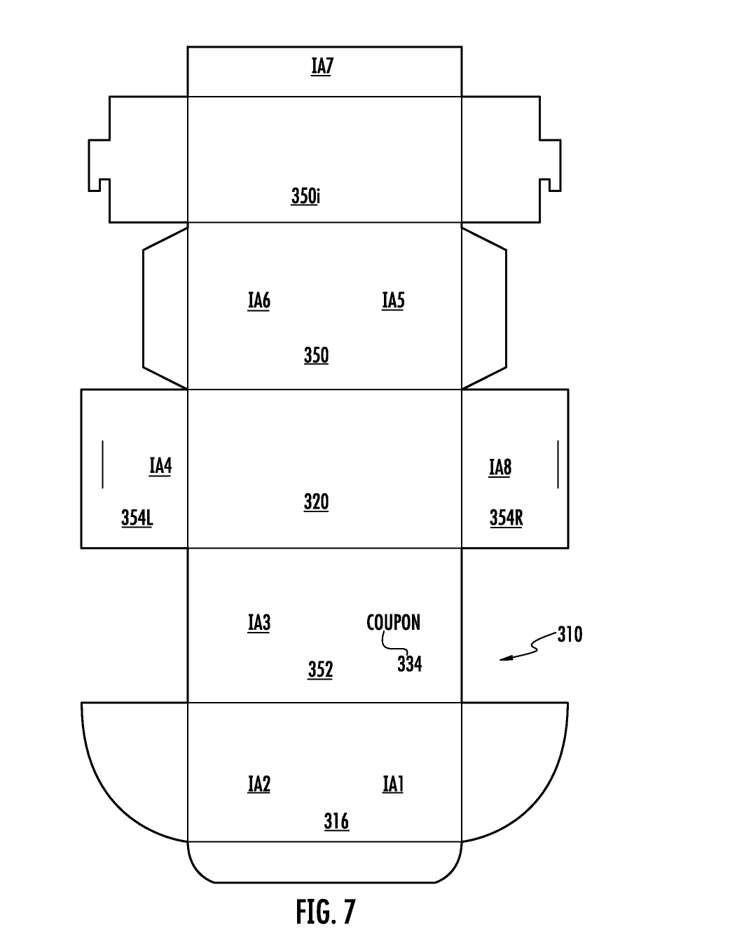

FIGS. 5 through 7 show yet another exploitable advertisement scheme according to this invention; one that exploits (for third party advertising) the outsides of, and possibly insides to, most other shipping/packing boxes. Representative boxes include those used by individuals for packing their wares for major moving/transport. It is believed that retailers, especially home building suppliers and/or home repair service providers might most exploit the sold spaces on boxes sold by FedEx, DHL and to a larger degree: U-Haul, Budget and still other cubed box container shippers like: MyWay, PackRat and PODS.

A greater emphasis for ad sales exists with disposable foodstuff packaging, like pizza boxes, bakery items and/or donut boxes to name a few. Still others might include the sandwich boxes from fast food restaurants, McDonalds, Burger King and Wendy's among them. For any such box 310, there would once more be a top side 316, bottom 320, front side 350, rear 352 and sides 354L and R. In addition to all of the exterior surfaces, box 310 includes inside equivalents (designated by letter “i”) for one or more flat surfaces. Admittedly, there must be some space S reserved for self-promotion. In the example pictured, Dave's Donuts has chosen to embellish front “face” 350 to box 310. Additional self-advertising, promotions, coupons for the primary food service provider may adorn the top/lid 316 and/or inside to same 316i. At the same time, however, ad space may be sold to third parties for the exterior to top 316 (Ads 1&2), side flap 354R (Ad 3), side interior 354Li (bar square/code 336), lid 316i (Inside Ads 1&2) and rear box interior 352i with its own representative coupon 334. Needless to say, should foodstuffs come in direct contact with these ads, they will generate less potential revenue if they can be fully or partially hidden through food contact. Nobody likes cutting up a pizza box and/or redeeming same, when the cutaway coupon is smeared with tomato sauce or extra cheese. To avert that possibility, it is understood that the interior advertising should be supplied with disposable tissues T for preventing foods from unduly interfering with committed ad space sales. Of course, when using any such tissue, that opens up the possibility of selling Tissue-based ads TA1 on one or both sides to that very tissue insert.

Still other boxed product concepts include the thick shipping packages for appliances like refrigerators, washers, dryers, dishwashers and the like. Also, the packages in which printers, faxes, even large reams of printer paper are potential advertising sources. For that matter, there is a LOT of open space on the non-business sides to each and every box shipment from retailers like Amazon.com and/or shoe-boot manufacturers that could benefit from a third party advertising program like the one specified herein.

Typically, the aforementioned boxes are made from heavy paper, polymer- or foil-reinforced paper and/or cardboards of varying thicknesses and weight holding grades.

While the present invention has been described and disclosed with respect to a single embodiment, it will be appreciated that many modifications and variations may be made without departing from the true spirit and scope of the invention. It is therefore the intent of the appended claims to cover all such variations and modifications falling within the spirit and scope hereof.

What is claimed is:

1. An envelope comprising a rectangular panel with parallel long and short sides, a front outer surface onto which a delivery address is made visible and a reverse side opposite the address side, said envelope including at least one integral third party advertising message on its reverse side.

2. The envelope of claim 1 wherein said advertising message includes a redeemable coupon.

3. The envelope of claim 1 wherein said advertising message includes a phone readable, bar code square.

4. The envelope of claim 1 wherein said advertising message is from at least one of a local vendor, a regional vendor, a statewide vendor, a national vendor and an international vendor.

5. The envelope of claim 1 wherein said advertising message is from at least one of a web-based vendor and a catalog-based vendor.

6. The envelope of claim 1 wherein said advertising message is printed over postage for stamp cancellation purposes.

7. A multi-dimensional shipping box comprising a top and bottom panel, front panel, rear panel and at least two side panels joining the top and bottom panels together, said shipping box including a plurality of integral third party advertising messages to at least one of: its bottom panel, front panel, rear panel and one or both side panels.

8. The shipping box of claim 7 wherein said advertising messages are included on at least one of: an outside surface of said shipping box and an inside surface of said shipping box.

9. The shipping box of claim 8 which is used for packaging foodstuff.

10. The shipping box of claim 9 which further includes at least one tissue insert for separating foodstuff from any inside third party advertising messages.

11. The shipping box of claim 10 wherein said tissue insert includes its own third party advertising messages.

12. The shipping box of claim 7 which is used for packaging consumer goods selected from the group consisting of an appliance, shoes and mail order clothes, books or videos.

13. The shipping box of claim 7 which is used for packaging a paper product selected from the group consisting of tissues and printer paper.

14. The shipping box of claim 7 wherein said third party advertising message includes at least one of: a redeemable coupon and a phone readable, square bar code.

15. The envelope of claim 7 wherein said advertising message is from at least one of a local vendor, a regional vendor, a statewide vendor, a national vendor and an international vendor.

16. The envelope of claim 7 wherein said advertising message is from at least one of a web-based vendor and a catalog-based vendor.

17. A method for generating third party advertising revenues for an envelope or package delivery service comprises:
adding one or more integral third party advertising messages to one or more surfaces of the envelope or package in a region which will not interfere with readability of envelope or packaging addressing.

18. The method of claim 17 wherein the advertising message is on a reverse of the address side of the envelope.

19. The method of claim 17 wherein the advertising message is on at least one of: an exterior to a top, bottom, front, rear or side panel of the packaging.

20. The method of claim 17 wherein the advertising message is on at least one of: an interior to a top, bottom, front, rear or side panel of the packaging.
